(19) United States
(12) Patent Application Publication
(10) Pub. No.: US 2025/0267418 A1
(43) Pub. Date: Aug. 21, 2025

(54) WIRELESS AUDIO TRANSMISSION SYSTEM

(71) Applicant: Sennheiser electronic SE & Co. KG, Wedemark (DE)

(72) Inventor: Norbert Werner, Hannover (DE)

(73) Assignee: Sennheiser electronic SE & Co. KG, Wedemark (DE)

(21) Appl. No.: 19/050,440

(22) Filed: Feb. 11, 2025

(30) Foreign Application Priority Data
Feb. 15, 2024 (DE) 102024104303.2

(51) Int. Cl. H04S 7/00; H04R 3/00; H04R 5/027

(52) U.S. Cl. CPC H04S 7/30; H04R 3/00; H04R 5/027; H04R 2420/07; H04S 2400/11; H04S 2400/13; H04S 2400/15

(57) ABSTRACT

A wireless audio transmission system (10) is provided comprising at least one wireless microphone (100) which is configured to capture an audio signal and to transmit it wirelessly, a wireless receiver (200) which is configured to receive the audio signals (101) transmitted by the at least one wireless microphone (100), and a position detector (300). The position detector (300) is configured to capture a distance and/or an orientation or at least one angle between the at least one wireless microphone (100) and the wireless receiver (200). Furthermore, an audio processing unit (500) serves to process the captured audio signals (101) of the at least one wireless microphone (100) based on the detected position information and/or the orientation information for the spatial perception of the audio signals of the at least one wireless microphone in an overall audio signal or to output the captured audio signals (101) of the at least one wireless microphone (100) together with the detected position information and/or the orientation information.

The present invention relates to a wireless audio transmission system and a method for audio transmission in a wireless audio transmission system.

In a wireless audio transmission system with at least one wireless microphone and a corresponding receiver, an audio signal can be recorded. If a camera is additionally used to record a video signal, then the audio signal and the video signal can be combined. If several wireless microphones are present, then a multi-channel audio signal can be recorded and, if necessary, linked to the video signal.

In the priority-substantiating German patent application the German Patent and Trademark Office has researched the following documents: U.S. Pat. Nos. 10/694,608 B2, 11/870,941 B2 and U.S. 2007/0214180 A1.

It is an object of the present invention to provide a wireless audio transmission system which enables more flexible use in the recording of audio signals.

This object is achieved by a wireless audio transmission system according to claim 1 and by a method for audio post-processing according to claim 7.

Thus, a wireless audio transmission system is provided which has at least one wireless microphone and a wireless receiver for receiving the audio signals which have been recorded and wirelessly transmitted by the wireless microphone. The audio signals of the at least one wireless microphone can be mixed together in the receiver. Alternatively, post-processing can take place outside the receiver. The wireless audio transmission system also has a position detector to capture a distance and an orientation or at least one angle (e.g. horizontal and/or vertical) between the at least one wireless microphone and the wireless receiver. The audio signals of the at least one wireless microphone received by the wireless receiver can be processed based on the position information (distance and orientation/angle between the wireless microphone and the wireless receiver). In particular, the spatial perception of an audio signal can be adapted based on the position information. Alternatively, the audio signal can be output or stored together with the position information.

The captured audio signals can be output directly, can be intermediately stored and then output and can be stored and output on request.

Optionally the receiver of the transmitted audio signals is provided in a unit with a camera, e.g. a Smartphone or a tablet.

By means of the position information the moving wireless microphone can be automatically tracked. The tracking can be taken into account in the overall audio signal. In particular, a dynamic stereo panning (i.e. pivoting) can be achieved without manual post-processing.

If the wireless microphone moves whilst the audio signals are being captured, the changed position information can be detected and taken into account during the audio processing. In particular, the position information captured by the position detector can be used to adapt the spatial perception of the audio signal in an overall audio signal. For example, if a user sings or speaks into a wireless microphone and walks from left to right, the position information captured can be used to reproduce the audio signal captured by this wireless microphone with a changed spatial perception. In the overall audio signal, the spatial perception of the audio signal from the wireless microphone changes whilst the wireless microphone moves in the room. If this information is linked to the video signal accordingly, the combined audio/video signal can enable an improved spatial perception.

By dynamically capturing the position of the at least one wireless microphone relative to the receiver (or vice versa), this position information can be used to dynamically position a mono audio signal from a wireless microphone in the stereo panorama of the overall audio signal in the receiver or to adjust the position.

Furthermore, the position information (in particular the distance information) can be used to adapt the audio signal captured by the corresponding wireless microphone with regard to its level in the overall audio signal. If the position of the wireless microphone moves away, then the level of the audio signal captured by the wireless microphone can be lowered. If the distance between the wireless microphone and the wireless receiver decreases, then the level of the audio signal captured by the wireless microphone can be increased. This can be carried out to achieve an improved adaptation of the audio signal of the wireless microphone in the overall audio signal to the position and/or distance to the wireless receiver. If the wireless receiver is mechanically coupled to a video camera, then this information regarding the audio signal of the wireless microphone can be taken into account in the overall audio/video signal.

According to one aspect of the present invention, the position information of the wireless microphone (relative to the position of the wireless receiver) can be embedded as metadata in the audio signal. Thus audio post-processing based on the position information can be carried out.

The determination of the position information can be based on a different wireless protocol than the wireless audio transmission between the microphone and receiver. For example, the position information can be determined using Bluetooth Low Energy BLE.

According to a further aspect of the present invention, the wireless audio transmission system comprises a video camera which is coupled to the wireless receiver and captures a video signal. The video camera can comprise a lens and metadata relating to the lens (angle of view) can be captured and embedded, for example, in the audio signal. This metadata relating to the video camera can be used, for example, to influence a level of an audio signal captured by the wireless microphone. The metadata of the camera and in particular of the lens can be embedded in the video signal.

The wireless receiver can also be optionally integrated into the camera.

According to one aspect of the present invention, the wireless audio transmission system is configured as an audio-video system in which an audio signal is captured by means of the wireless microphones and is combined with a video signal which has been captured, for example, by a video camera which is coupled to the wireless receiver.

According to one aspect, the wireless microphone or wireless receiver (or a separate position detector) can have an antenna array to enable directional detection.

The invention also relates to a method for audio post-processing for a wireless audio transmission system, which comprises at least one wireless microphone, a wireless transmitter and a position detector for detecting a distance and an orientation or at least one angle between the wireless microphone and the wireless receiver. An audio signal is captured by the at least one wireless microphone. The audio signal is transmitted from the wireless microphone to a wireless receiver. A distance and/or an orientation or an angle between the wireless microphone and the wireless receiver is captured. The captured audio signals are processed based on the detected position information and the orientation information to adapt a spatial perception of the audio signals of the at least one wireless microphone in an overall audio signal, or the captured audio signals are output together with the detected position information and the orientation information.

Further embodiments of the invention are the subject of the dependent claims.

Advantages and exemplary embodiments of the invention are explained in more detail below with reference to the drawing.

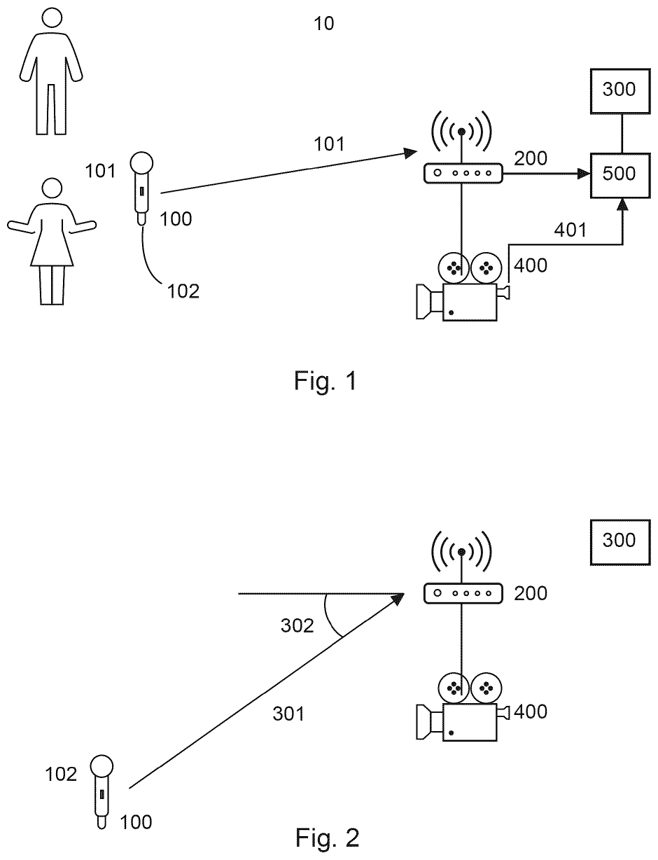

FIG. 1 shows a schematic structure of a wireless audio transmission system, and

FIG. 2 shows another schematic representation of a wireless audio transmission system.

FIG. 1 shows a schematic structure of a wireless audio transmission system. The wireless audio transmission system 10 comprises at least one wireless microphone 100 and a wireless receiver 200, which is able to receive the audio signals 101 transmitted by the wireless microphone 100 via a first transmission protocol. Optionally, a camera 400 can be provided, which can capture a video signal. Optionally, the wireless receiver 200 can be mechanically attached in or to the camera 400.

The camera 400 captures a video signal and the wireless microphone 100 and the wireless receiver 200 captures an audio signal 101. The video signal 401 and the audio signal 101 can be synchronized in the camera 400 or in a subsequent audio post-processing unit 500.

The wireless audio transmission system 10 further comprises a position detector 300. The position detector 300 serves to capture the position 102 of the at least one wireless microphone. Alternatively, the position detector 300 can be configured to capture the position of the wireless receiver 200 relative to the at least one wireless microphone 100. The position detector 300 can be implemented in the wireless receiver 200 or in the wireless microphone 100.

Alternatively, the position detector 300 can also be configured as a dedicated unit. The position detector 300 thus provides position information 102 of the at least one wireless microphone 100 and/or the wireless receiver 200 in order to determine a relative position of the microphone 100 with respect to the wireless receiver 200. The relative position can include the distance and at least one angle (e.g. horizontal angle and/or vertical angle) or an orientation. In particular, in the event that the wireless receiver 200 is mechanically coupled to the video camera 400, the position information captured by the position detector 300 can be taken into account. Based on the position information determined by the position detector 300 and the audio signals received by the wireless receiver 200, these two signals can be combined to determine both the audio signal 101 and the current position 102 of the wireless microphone 100. If the position 102 of the wireless microphone 100 changes relative to the wireless receiver 200, this can be taken into account in an audio post-processing unit 500 in order to take into account a spatial perception of the audio signals of the at least one wireless microphone 100 in an overall audio signal.

In the case of stereo audio, for example, the angle information can be translated into panning. The distance could affect the volume.

In the case of binaural audio, the captured angle could affect the binaural audio signals by means of HRTF.

In the case of multi-channel audio, there are additional rendering methods to map an audio object to, for example, a 5.1 speaker system.

In the case of pure storage of the directional information, a data format such as ADM could be used. A mix for any audio format can then be created in post-processing.

FIG. 2 shows a further schematic representation of a wireless audio transmission system. The wireless audio transmission system 10 has at least one wireless microphone 100, a wireless receiver 200, a camera 400 and a position detector 300. The wireless receiver 200 can optionally be mechanically attached in, on or with the camera 400. In this exemplary embodiment, the position detector 300 can be implemented in the wireless receiver 200 or in the camera 400. The position detector 300 can take into account a distance 301 to the wireless microphone 100 and an angle 302 or an orientation. The angle 302 can in particular designate the orientation of the wireless microphone 100 in relation to a line of sight of the camera 400. Alternatively, two angles (horizontal, vertical) can also be used.

Optionally, the position information of the wireless microphone 100 can be embedded as metadata in the audio signal captured and received by the at least one wireless microphone 100. It is thus possible to use the captured position information in post-processing of the captured audio signals.

By means of the position detector 300, it is possible to detect and track a position 102 of the at least one wireless microphone 100. Based on the captured angle information 302, the mono microphone signal can be dynamically positioned in a stereo panorama in the receiver 200, for example.

The distance information 301 can be used to adjust a level of the audio signal captured by the wireless microphone 100 in an overall audio signal. Thus, a dynamic adjustment of the level of the microphone signal in an overall audio signal can be carried out depending on the relative position of the microphone to the receiver. For example, moving the microphone closer can lead to an increase in the level of the output signal. Increasing the distance between the wireless receiver 200 and the wireless microphone 100, on the other hand, can lead to a reduction in the level of the microphone signal. This can, for example, facilitate immersive audio production in the further processing chain.

The position detector 300 can operate, for example, based on a Bluetooth Low Energy protocol. In particular, Bluetooth Direction Finding can be used to detect the angles (optionally in multiple axes) between the wireless microphone and the wireless receiver. Optionally, the wireless receiver then has multiple antennae, for example in the form of an antenna array, to determine an angle. A distance between the receiver and the microphone can be determined, for example, based on the signal strength RSSI or on a distance measurement based on Bluetooth.

The position detector 300 can be implemented in the wireless receiver 200 or in the video camera 300. Alternatively, the position detector 300 can be provided in another unit that enables a relative position between the wireless microphone and the wireless receiver to be captured.

Optionally, the wireless receiver 200 and the position detector 300 can be integrated into the video camera 400.

Optionally, the wireless audio transmission between the microphone and the receiver can be based on a first transmission protocol. Optionally, the position detector can use a second transmission protocol to detect the position information of the wireless microphone.

Optionally, the audio signal captured by the wireless microphone can be stored in the microphone and transmitted later. The position information can be stored in the receiver in this case. Thus, a subsequent transmission of the audio signal and a post-processing of the audio signal can take place.

Optionally, a panning or binauralization can be used to mix a mono microphone signal with a two-channel signal.

Optionally, the position detector can be located in the microphone. And optionally, the microphone can store the position information and this can be transmitted later.

Optionally, the camera can be a 360° or 3D camera. With such a camera, a manual alignment or tracking of the audio signals can be simplified.

### REFERENCE LIST

10 Wireless audio transmission system
100 Wireless microphones
101 Audio signals
102 Position
200 Wireless receivers
300 Position detector
30 Distance
302 Angle
400 Camera
401 Video signal
500 Audio post-processing unit

1. Wireless audio transmission system (10), comprising
at least one wireless microphone (100) which is configured to capture an audio signal and transmit it wirelessly,
a wireless receiver (200) which is configured to receive the audio signals (101) transmitted by the at least one wireless microphone (100),
a position detector (300) which is configured to capture a distance and/or an orientation or at least one angle between the at least one wireless microphone (100) and the wireless receiver (200), and
an audio processing unit (500) which is configured to process the captured audio signals (101) of the at least one wireless microphone (100) based on the detected position information and/or the alignment information for the spatial perception of the audio signals of the at least one wireless microphone in an overall audio signal.

2. Wireless audio transmission system (10) according to claim 1, wherein
the audio processing unit (300) is configured to adapt a level of the captured audio signal (110) depending on the detected position information.

3. Wireless audio transmission system (10) according to claim 1, further comprising
a camera (400), wherein the wireless receiver (200) and the position detector (300) are coupled to the camera (400) so that position information and/or orientation information related to a viewing axis of the camera (400) is captured by means of the position detector (300).

4. Wireless audio transmission system (10) according to claim 2, wherein
position and/or orientation information is embedded as metadata in the audio signal.

5. Wireless audio transmission system (10) according to claim 2 wherein
a transmission of the audio signals takes place based on a first audio transmission protocol and a capturing of the position and/or orientation information takes place based on a second wireless transmission protocol.

6. Wireless audio transmission system (10), comprising
at least one wireless microphone (100) which is configured to capture an audio signal and transmit it wirelessly,
a wireless receiver (200) which is configured to receive the audio signals (101) transmitted by the at least one wireless microphone (100),
a position detector (300), which is configured to capture a distance and/or an alignment or at least one angle between the at least one wireless microphone (100) and the wireless receiver (200) and
an audio processing unit (500) which is configured to output the captured audio signals (101) of the at least one wireless microphone (100) together with the detected position information and/or the orientation information.

7. Wireless audio transmission system (10) according to claim 1, wherein
the captured audio signal is output directly, is stored and then output or is stored and output on request.

8. Method for audio post-processing for a wireless audio transmission system (10) which comprises at least one wireless microphone, a wireless transmitter and a position detector for detecting a distance and an orientation or at least one angle between the wireless microphone and the wireless receiver, comprising the steps:
capturing an audio signal (101) by the at least one wireless microphone (100),
transmitting the audio signal from the wireless microphone to a wireless receiver,
detecting a distance and/or an orientation or an angle between the wireless microphone (100) and the wireless receiver (200), and
processing the captured audio signals based on the detected position information and the orientation information to adapt a spatial perception of the audio signals of the at least one wireless microphone in an overall audio signal.

9. Method for audio post-processing for a wireless audio transmission system (10) which comprises at least one wireless microphone, a wireless transmitter and a position detector for detecting a distance and an orientation or at least one angle between the wireless microphone and the wireless receiver, comprising the steps:
capturing an audio signal (101) by the at least one wireless microphone (100),
transmitting the audio signal from the wireless microphone to a wireless receiver,
detecting a distance and/or an orientation or an angle between the wireless microphone (100) and the wireless receiver (200), and
outputting the captured audio signals together with the detected position information and the orientation information.
